(19) United States
(12) Patent Application Publication
(10) Pub. No.: US 2020/0194742 A1
(43) Pub. Date: Jun. 18, 2020

(54) Cap Assembly for Electrochemical Cells

(71) Applicants: Robert Bosch Battery Systems, LLC, Orion, MI (US); Robert Bosch GmbH, Stuttgart (DE)

(72) Inventor: Jeffrey Buckholz, Rochester Hills, MI (US)

(21) Appl. No.: 16/222,499

(22) Filed: Dec. 17, 2018

(51) Int. Cl. H01M 2/04; H01M 2/02; H01M 2/10

(52) U.S. Cl. CPC H01M 2/046; H01M 2/105; H01M 2/022

(57) ABSTRACT

A battery module includes an array of electrochemical cells. Each cell includes a cap assembly that supports the cell within the array, and electrically isolates the cell from adjacent cells of the array. The cap assembly includes a first cap disposed on one end of the cell and a second cap disposed on the opposed end of the cell. Each of the first cap and the second cap include a tubular body that has an inner surface that has a shape and dimensions that correspond to the shape and dimensions of the cell outer surface, and a lip that protrudes inward from the inner surface. The lip is disposed at a first end of the body, and a terminal end of the lip defines an opening in the first end of the body.

### BACKGROUND

Battery packs provide power for various technologies ranging from portable electronics to renewable power systems and environmentally friendly vehicles. For example, hybrid electric vehicles use a battery pack and an electric motor in conjunction with a combustion engine to increase fuel efficiency. Battery packs may be formed of a plurality of battery modules, where each battery module includes several electrochemical cells. Within the battery module, the cells are electrically connected in series or in parallel. Likewise, the battery modules are electrically connected in series or in parallel within the battery pack.

Different cell types have emerged in order to deal with the space requirements of a very wide variety of applications and installation situations, and the most common types used in vehicles are cylindrical cells, prismatic cells, and pouch cells. Regardless of cell type, each cell includes an electrode assembly that is sealed within a cell housing along with an electrolyte to form a power generation and storage unit. The electrode assembly may include an alternating arrangement of positive and negative electrode elements separated by intermediate separator plates, and can be provided in various configurations. The electrode assembly of a cylindrical cell is typically formed by winding an elongated electrode pair into a jelly-roll configuration.

Due to their curved shape, cylindrical cells do not pack efficiently in a battery module. In addition, it is advantageous to provide spacing between adjacent cells within the battery module in order to minimize the propagation of heat from cell to cell, and to permit a cooling fluid to be passed between the cells to remove heat from the cells. Although it is known to provide cell support structures within a battery module, some conventional support structures are complex in structure and have sufficient bulk to further reduce the battery module packing efficiency. A device is needed that is simple to use and manufacture, can provide a stable, ordered arrangement of cylindrical cells within the battery module, and can maintain a spacing between adjacent cells of a cell array while occupying a minimal volume of the space within the battery module.

### SUMMARY

In some aspects, a cap assembly is provided for an electrochemical cell. The electrochemical cell has a cell first end, a cell second end that is opposed to the cell first end, and a cell outer surface. The cap assembly includes a first cap configured to receive the cell first end; and a second cap configured to receive the cell second end. Each of the first cap and the second cap include a tubular body. The body includes an inner surface that has a shape and dimensions that correspond to the shape and dimensions of the cell outer surface; and a lip that protrudes inward from the inner surface. The lip is disposed at a first end of the body, and a terminal end of the lip defines an opening in the first end of the body.

In some embodiments, the body has a second end that is opposed to the first end, and the second end of the body is free of a lip.

In some embodiments, the opening has a dimension that is at least 50 percent of a corresponding dimension of the inner surface.

In some embodiments, an outer surface of the body includes surface features that enhance fixation of an adhesive to the outer surface.

In some embodiments, the surface features comprise grooves that alternate with ridges along a circumference of the body. The grooves and the ridges each extend between the first end of the body and a second end of the body, and the second end of the body is opposed to the first end of the body.

In some embodiments, the surface features comprise a helical thread.

In some embodiments, the surface features comprise a knurl.

In some embodiments, the body has a circular cross-sectional shape, and the opening has a circular cross-sectional shape.

In some embodiments, the opening is centered on the first end of the body.

In some aspects, a battery module includes an array of electrochemical cells. Each electrochemical cell includes a cell first end; a cell second end that is opposed to the cell first end; a cell outer surface; and a cap assembly. The cap assembly includes a first cap disposed on the cell first end; and a second cap disposed on the cell second end. Each of the first cap and the second cap include a tubular body. The body has an inner surface that has a shape and dimensions that correspond to the shape and dimensions of the cell outer surface. In addition, the body has a lip that protrudes inward from the inner surface. The lip is disposed at a first end of the body, and a terminal end of the lip defining an opening in the first end of the body.

In some embodiments, the body includes a second end that is opposed to the first end, each of the first cap and the second cap have a cap length that corresponds to a distance between the first end of the body and the second end of the body, each cell has a cell length that corresponds to a distance between the cell first end and the cell second end, and a ratio of the cap length to the cell length is in a range of 0.05 to 0.30.

In some embodiments, the body has a second end that is opposed to the first end, and the second end of the body is free of a lip.

In, some embodiments, the opening has, a dimension that is at least 50 percent of a corresponding dimension of the inner surface.

In some embodiments, an outer surface of the body includes surface features that enhance fixation of an adhesive to the outer surface.

In some embodiments, a first terminal protrudes from the cell first end of each cell, and the opening in the first cap surrounds the first terminal.

In some embodiments, the cell housing of each cell of the cell array is cylindrical, and all the cells of the cell array have the same diameter.

In some embodiments, at least one cell of the cell array is the surrounded by other cells of the cell array in such a way that the first cap of the at least one cell is in direct contact with the first cap of six other cells of the cell array, and the second cap of the at least one cell is in direct contact with the second cap of six other cells of the cell array.

In some embodiments, the outer surface of the at least one cell is spaced apart from the outer surfaces of the six other cells, and the distance between the outer surface of the at least one cell and the outer surfaces of the six other cells corresponds to twice the thickness of the body, where the thickness of the body is the distance between the inner surface of the body and an outer surface of the body.

Since the typical battery pack and/or module has a polygonal (rectangular or other) prismatic shape, cylindrical cells provide a relatively low volumetric efficiency within a polygonal battery pack or module when compared to, for example, prismatic cells. This volumetric inefficiency can be minimized by employing a close-packed arranaement of cells with in the battery pack or module. By providing spacer caps on the ends of each cell to ensure a space exists between adjacent cells, and by providing the cell-and-cap assembly in a close-packed arrangement within a battery module or pack, volumetric efficiency is maximized while providing a stable, ordered and arrangement of cylindrical cells. In addition, a spacing is maintained between adjacent cells of a cell array that allows for passage of a cooling fluid, whereby temperature of the cells can be controlled.

### BRIEF DESCRIPTION OF THE DRAWINGS

FIG. 1 is a perspective view of a portion of a battery module illustrating an array of cells including cell cap assemblies, where a housing of the battery module is shown schematically using broken lines.

FIG. 2 is a perspective view of a cylindrical cell including a cut-away portion illustrating an electrode assembly disposed in the cell.

FIG. 3 is a perspective view of a cylindrical cell including a cell cap assembly having a first cap and a second cap.

FIG. 4 is a perspective view of the first end of the first cap of FIG. 3.

FIG. 5 is a perspective view of the second end of the first cap of FIG. 3.

FIG. 6 is a perspective view of two adjacent cells of the cell array isolated from the remaining cells of the cell array to illustrate details of the interrelationship between adjacent cells and respective cell cap assemblies.

FIG. 7 is a perspective view of an alternative embodiment first cap.

FIG. 8 is a perspective view of another alternative embodiment first cap.

FIG. 9 is a schematic illustration of a hexagonal-pack arrangement of the cells and respective cell cap assemblies within a battery module housing, where all cells of the cell array have the same diameter and the battery module housing is a rectangular prism.

FIG. 10 is a schematic illustration of a square-pack arrangement of the cells and respective cell cap assemblies within a battery module housing, where all cells of the cell array have the same diameter and the battery module housing is a rectangular prism.

FIG. 11 is a schematic illustration of a portion of an alternative arrangement of the cells and respective cell cap assemblies within a battery module housing, where the cell array includes cells of two different diameters and the battery module housing is shown schematically using broken lines.

FIG. 12 is a schematic illustration of another alternative arrangement of the cells and respective cell cap assemblies within a battery module housing, where the cell array includes cells of three different diameters and the battery module housing is a circular prism.

### DETAILED DESCRIPTION

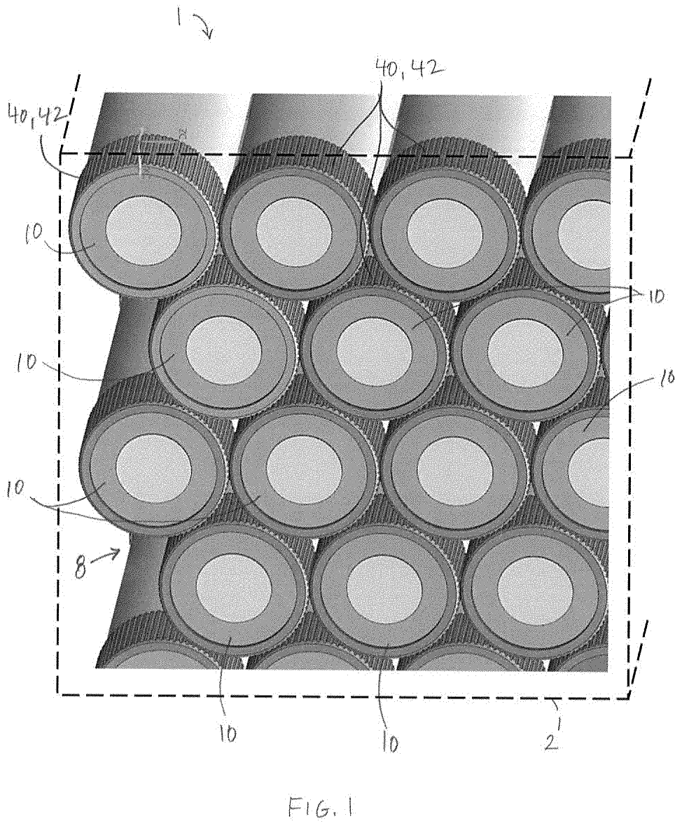

Referring to FIG. 1, a battery module 1, is used alone or in combination with other battery modules (not shown) to provide electrical power. The battery module 1 includes an array 8 of cylindrical electrochemical cells 10. Within the battery module 1, the cells are electrically connected in series or in parallel via conventional methods, for example via one or more bus bars or plates (not shown). Likewise, two or more battery modules 1 may be electrically connected in series or in parallel to provide a battery pack (not shown). The cells 10 are supported within the battery module 1 and relative to each other via a cap assembly 40 that is provided on each cell 10. The cap assembly 40 includes a first cap 42 disposed on one end 14 of the cell 10, and a second cap 44 disposed on the opposed end 20 of the cell 10. The cells 10 are arranged in the array 8 in which the spacer caps 42, 44 of a given cell 10 directly contact the spacer caps 42, 44 of each adjacent cell 10. The cap assembly 40, including the first and second spacer caps 42, 44, cooperate with the cells 10 to provide a stable, ordered arrangement of the cells 10 within a battery module housing 2, electrically isolate the cells 10 from each other, and maintain a predetermined spacing between adjacent cells 10. The cap assembly 40 is described in detail below.

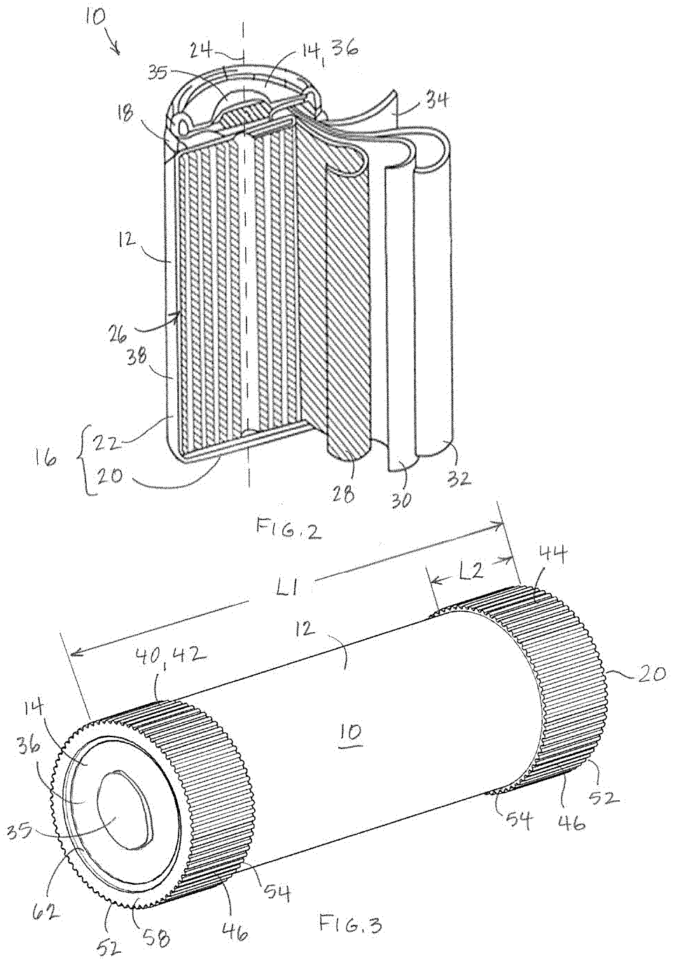

Referring to FIGS. 2 and 3, the cells 10 are cylindrical lithium-ion cells. Each cell 10 includes a cylindrical cell housing 12 having a container portion 16 and a lid 14 that closes an open end of the container portion 16. The lid 14 is sealed to the container portion 16 by an electrically insulating gasket 18. The container portion 16 includes a closed end 20 that is disposed at an end of the cell housing 12 that is opposed to the lid 14, and a cell housing sidewall 22 that protrudes from the closed end 20. The container portion 16 is elongated along a longitudinal axis 24 that extends between the lid 14 (e.g., the cell housing first end) and the closed end 20 (e.g., the cell housing second end). That is, the longitudinal axis 24 extends in parallel to the cell housing sidewall 22. The cell housing 12 has a length L1 that corresponds to a distance between the cell housing first and second ends 14, 20.

An electrode assembly 26 is sealed within the cell housing 12 along with an electrolyte to form a power generation and storage unit. The electrode assembly 26 includes a stacked arrangement of a positive electrode 28, a first separator 30, a negative electrode 32 and a second separator 34, in which the stacked arranged has been rolled to provide a “jelly roll”. One of the electrodes, for example the positive electrode 28, is electrically connected to the lid 14, which serves as a positive terminal 36 of the cell 10. In addition, the other electrode, for example the negative electrode 32, is electrically connected to the container portion 16, which serves as a negative terminal 38 of the cell 10.

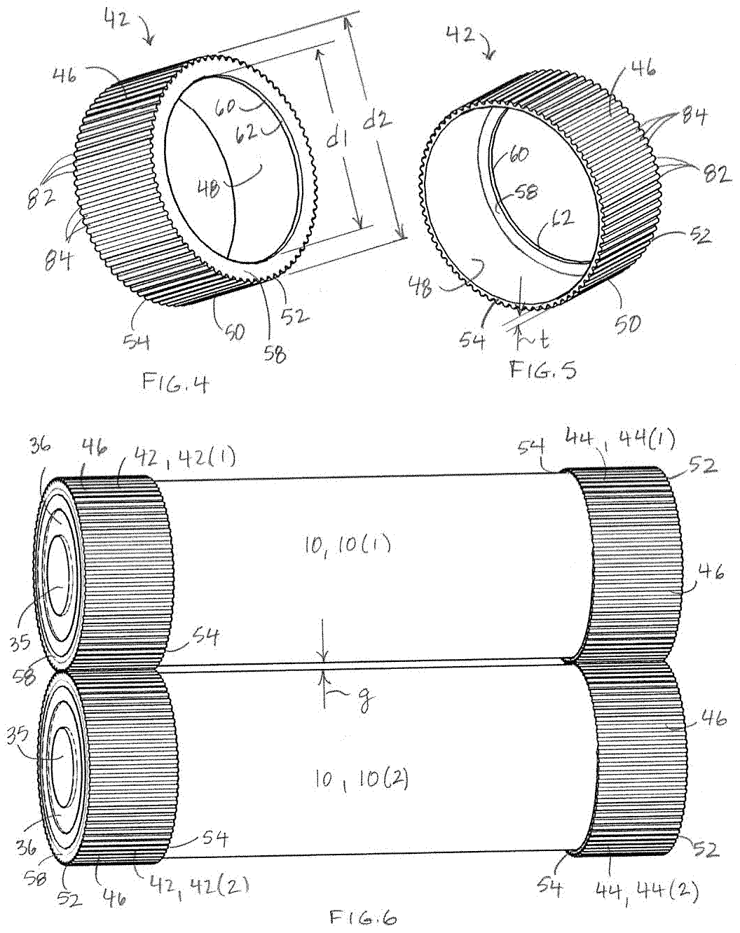

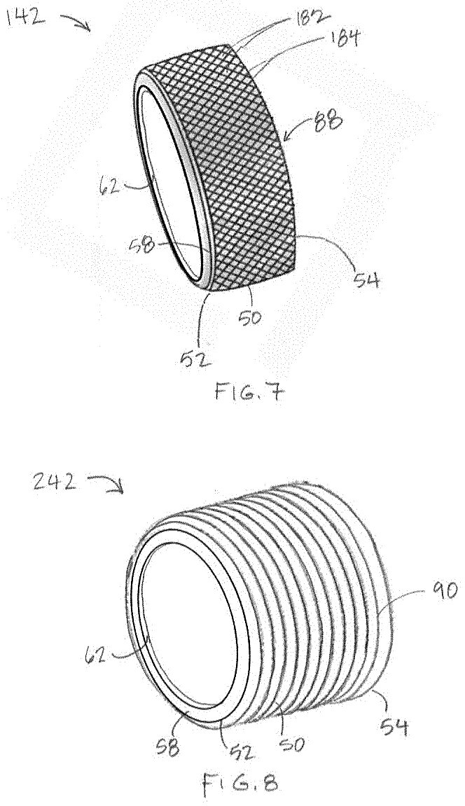

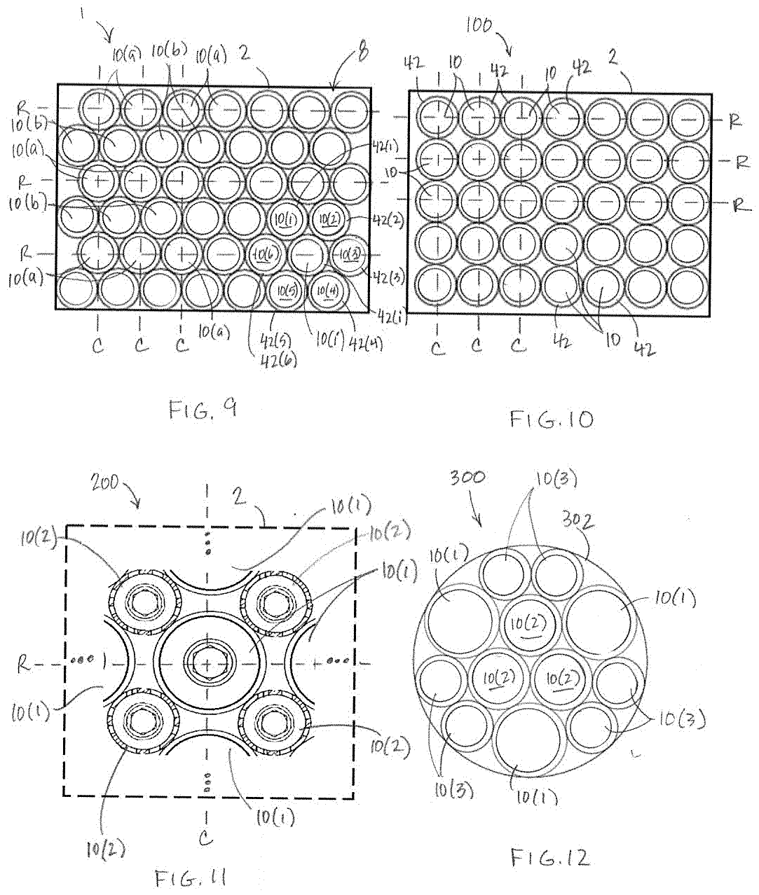

Referring to FIGS. 3-6, the cap assembly 40 includes the first cap 42 that is configured to receive the cell first end 14, and the second cap 44 that is configured to receive the cell second end 20. The first and second caps 42, 44 are identical, and so only the first cap 42 will be described. The first cap 42 includes a tubular body 46. In particular, the body 46 is a generally cylindrical tube having a first end 52, and a second end 54 that is opposed to the first end 52. The body 46 has an inner surface 48 that has a shape and dimensions that correspond to the shape and dimensions of the cell outer surface (e.g., the shape and dimensions of the cell housing 12). In the illustrated embodiment, the body inner surface 48 has a cylindrical shape to correspond to the cylindrical shape of the cell housing 12. In some embodiments, the diameter of the body inner surface 48 is set to provide a tolerance fit with the cell housing first end 14. In other embodiments, the diameter of the body inner surface 48 is set to provide a press fit with the cell housing first end 14. The inner surface 48 is generally free of texture and/or surface features.

The body 46 includes a lip 58 that protrudes inward from the inner surface 48. The lip 58 is disposed at the first end 52 of the body 46. A terminal end 60 of the lip 58 (e.g., a surface of the lip 58 that faces a centerline of the body 46) defines an opening 62 in the first end 52 of the body 46. The opening 62 is circular, and is centered on the body first end 42. The opening 62 is large relative to the size of the body first end 52. For example, the opening 62 has a dimension that is at least 50 percent of a corresponding dimension of the body first end 52. In the illustrated embodiment, the opening 62 has a diameter d1 that is about 85 percent of the diameter d2 of the body first end 52.

The second end 54 of the body 46 is free of a lip, and thus provides an unobstructed opening that receives an end (for example, the first end 14) of the cell housing 12 therein.

The outer surface 50 of the body 46 includes surface features that enhance engagement with the outer surfaces of adjacent caps 42. For example, the surface features may include elongated, linear grooves 84 that alternate with elongated, linear ridges 82 along a circumference of the body 46. The grooves 84 and the ridges 82 each extend between the first and second ends 52, 54 of the body 46.

Referring to FIG. 6, in some embodiments, an adhesive is used to secure the first cap 42(1) of one cell 10(1) to the first cap 42(2) of an adjacent cell 10(2), and to secure the second cap 44(1) of the one cell 10(1) to the second cap 44(2) of the adjacent cell 10(2). In these embodiments, the grooves 84 in the body 46 receive adhesive, and facilitate fixation of one cell cap with another.

In other embodiments, the grooves 84 and ridges 82 of the cell cap 42(1), 44(1) of one cell 10(1) form an interlocking engagement with the corresponding grooves 84 and ridges 82 of the cell cap 42(2), 44(2) of an adjacent cell 10(2). The interlocking engagement may be employed alone, or in combination with an adhesive, to retain the cells in the desired array configuration.

Referring to FIG. 7, an alternative embodiment first cap 142 is identical to the first cap 42 illustrated in FIGS. 3-6, except that the first cap 142 of FIG. 7 includes surface features in the form of a knurl 88. That is, the first cap outer surface 50 has a texture provided by alternating diamond-shaped protrusions 182 and recesses 184.

Referring to FIG. 8, another alternative embodiment first cap 242 is identical to the first cap 42 illustrated in FIGS. 3-6, except that the first cap 242 of FIG. 8 includes surface features in the form of a helical thread. That is, the first cap outer surface 50 has a texture provided by a helical thread 90 that extends from the body first end 52 to the body second end 54.

The first cap 42 may be formed of an electrically insulating material such as plastic.

Referring again to FIG. 3, the first cap 42 has a cap length L2 that corresponds to a distance between the body first end 52 and the body second end 54. A ratio of the cap length L2 to the cell length L1 is in a range of 0.05 to 0.30. In the illustrated embodiment, the ratio of the cap length L2 to the cell length L1 is about 0.15. Since the cap length L2 is small relative to that of the cell length L1, most of the cell housing sidewall 22 is not covered by the first and second cell caps 42, 44, and instead remains exposed to the environment. Since most of the cell housing sidewall 22 is exposed to the environment, a cooling fluid passing through the cell array can efficiently remove heat from the cells 10.

As previously discussed, each cell 10 of the cell array 8 is supported within the battery module housing 2, and relative to other cells 10 of the cell array 8, via the cap assemblies 40 disposed on each cell 10. That is, each cell 10 of the cell array includes a first cap 42 disposed on the first end 14 of the cell housing 12, and a second cap 44 disposed on the second end 20 of the cell housing 12. When the first cap 42 is disposed on the cell housing first end 14, the cell housing first end 14 abuts the body inner surface 48 at the lip 58, and the positive terminal 36 is accessible via the opening 62. In the illustrated embodiment, the lid 14, which serves as the positive terminal 36, includes a protrusion 35 that is surrounded by and extends into the opening 62. The protrusion 35 may serve as a welding location that is connected to a bus bar (not shown) via welding. Similarly, when the second cap 44 is disposed on the cell housing second end 20, the cell housing second end 20 abuts the body inner surface 48 at the lip 58, and a portion of the negative terminal 38 (e.g., the portion associated with the second end 20) is accessible via the opening 62. In this configuration, the body second ends 54 of the first and second caps 42, 44 are disposed between the body first ends 52 of the first and second caps 42, 44.

Referring to FIGS. 1 and 5-6, within the battery module housing 2, the cells 10 are arranged in the array 8 with the spacer caps 42, 44 of a given cell 10(1) in direct contact with the spacer caps 42, 44 of each adjacent cell 10(2). As can be seen in FIG. 6, which illustrates two adjacent cells 10(1), 10(2) including respective cap assemblies 40(1), 40(2) of the cell array 8 isolated from the remaining cells 10 of the cell array 8, the first cap 42(1) of the given cell 10(1) has tangential contact with the first cap 42(2) of the adjacent cell 10(2). Likewise, the second cap 44(1) of the given cell 10(1) has tangential contact with the second cap 44(2) of the adjacent cell 10(2). Due to the thickness of the body 46, the outer surface of the sidewall 22(1) of the given cell 10(1) is spaced apart from the outer surface of the sidewall 22(2) of the adjacent cell 10(2), whereby a gap g exists between the sidewalls 22(1), 22(2) of the adjacent cells 10(1), 10(2). The gap g allows for passage of coolant fluid between the cells 10(1), 10(2). The distance between the outer surface of the sidewall 22(1) of the given cell 10(1) and the outer surface of the sidewall 22(2) of the adjacent cell 10(2) corresponds to twice the thickness t of the body 46, where the thickness t of the body 46 is the distance between the body inner surface 48 and the body outer surface 50.

In cell arrays having several rows R and columns C of cells 10, each cell 10 of the array is adjacent to multiple other cells 10 of the array. For example, in the array 8 illustrated in FIGS. 1 and 9, the cells 10, including the cap assemblies 40, are maintained in a hexagonal, or close-packed, arrangement via the respective cap assemblies 40. In this arrangement, certain cells 10(a) of the cell array 8 are arranged in rows R and columns C, and other cells 10(b) of the cell array 8 are disposed in the interstitial spaces between the rows R and the columns C. In addition, an inner cell 10(i) may be adjacent to six other cells 10(1), 10(2), 10(3), 10(4), 10(5), 10(6). That is, the first cap 42(i) of the inner cell 10(i) has tangential contact with the first cap 42(1), 42(2), 42(3), 42(4), 42(5), 42(6) of the adjacent cells 10(1), 10(2), 10(3), 10(4), 10(5), 10(6). Likewise, the second cap (not shown) of the inner cell 10(i) has tangential contact with the second cap (not shown) of the adjacent cells 10(1), 10(2), 10(3), 10(4), 10(5), 10(6). Each first and second cap 42, 44 has a predetermined wall thickness that provides a space between the cell housings 12 of adjacent cells when the cells 10 are in this configuration. In addition, the cap assembly 40 electrically isolates each cell 10 from adjacent cells and provides the gap g therebetween, whereby a cooling fluid can be used to maintain a desired cell temperature.

Referring to FIG. 10, the array 8 is not limited to the hexagonal arrangement illustrated in FIGS. 1 and 9. For example, a battery module 100 may include an alternative cell array 108 in which the cells 10 have a “square packing” arrangement, in which the cells 10, including the cap assemblies 40, are arranged in rows R and columns C, and in which each cell 10 directly contacts a single cell 10 of each of the adjacent rows and each of the adjacent columns.

The cell arrays 8, 108 shown in FIGS. 9 and 10 illustrate exemplary cell packing arrangements for arrays in which every cell 10 has the same diameter. It is understood, however, that an alternative embodiment cell array 208 (FIG. 11) may include cells 10 of differing diameter, which allows for alternative cell packing arrangements of the cylindrical cells. In cell array 208, there are cells 10(1) having a first size (e.g., first diameter) which constitute the rows R and columns C of the array 208, and cells 10(2) of a smaller, second size (e.g., second diameter) which are provided in the interstitial spaces between the rows R and columns C.

FIG. 12 shows yet another alternative cell packing arrangement of cylindrical cells 10, illustrating another cell array 308 that includes three different sized cells 10(1), 10(2), 10(3) in a module housing 302 having a cylindrical shape.

Although the cell 10 is described herein as being a lithium-ion cell, the cell 10 is not limited to having a lithium-ion chemistry. For example, the cell 10 may have other chemistries, including aluminum-ion, alkaline, nickel-cadmium, nickel metal hydride, or other appropriate chemistry.

Moreover, although the cell 10 is described as having a cylindrical shape, the cell 10 may be formed in an alternative shape, such as a prismatic or a pouch shape. For cells having an alternative shape, the body 46 of the first and second caps 42, 44 has a corresponding shape.

Although the positive electrode 28 is described here as being electrically connected to the lid 14, and the negative electrode 32 is described here as being electrically connected to the container portion 16, it is understood that the cell 10 may alternatively be configured so that the positive electrode 28 is electrically connected to the container portion 16, and the negative electrode 32 is electrically connected to the lid 14.

Selective illustrative embodiments of the battery module including electrochemical cells supported in an array by spacer caps are described above in some detail. It should be understood that only structures considered necessary for clarifying these devices have been described herein. Other conventional structures, and those of ancillary and auxiliary components of the battery module, electrochemical cells and/or the spacer caps, are assumed to be known and understood by those skilled in the art. Moreover, while working examples the battery module, electrochemical cells and/or the spacer caps been described above, the the battery module, electrochemical cells and/or the spacer caps are not limited to the working examples described above, but various design alterations may be carried out without departing from the devices as set forth in the claims.

What is claimed, is:

1. A cap assembly for an electrochemical cell, the electrochemical cell having a cell first end, a cell second end that is opposed to the cell first end, and a cell outer surface, the cap assembly comprising:
a first cap configured to receive the cell first end; and
a second cap configured to receive the cell second end,
wherein each of the first cap and the second cap include a tubular body, the body including:
an inner surface that has a shape and dimensions that correspond to the shape and dimensions of the cell outer surface; and
a lip that protrudes inward from the inner surface, the lip disposed at a first end of the body, and a terminal end of the lip defining an opening in the first end of the body.

2. The cap assembly of claim 1, wherein the body has a second end that is opposed to the first end, and the second end of the body is free of a lip.

3. The cap assembly of claim 1, wherein the opening has a dimension that is at least 50 percent of a corresponding dimension of the inner surface.

4. The cap assembly of claim 1, wherein an outer surface of the body includes surface features that enhance fixation of an adhesive to the outer surface.

5. The cap assembly of claim 4, wherein the surface features comprise grooves that alternate with ridges along a circumference of the body, where the grooves and the ridges each extend between the first end of the body and a second end of the body, and the second end of the body is opposed to the first end of the body.

6. The cap assembly of claim 4, wherein the surface features comprise a helical thread.

7. The cap assembly of claim 4, wherein the surface features comprise a knurl.

8. The cap assembly of claim 1, wherein the body has a circular cross-sectional shape, and the opening has a circular cross-sectional shape.

9. The cap assembly of claim 1, wherein the opening is centered on the first end of the body.

10. A battery module comprising an array of electrochemical cells, each electrochemical cell comprising:
a cell first end;
a cell second end that is opposed to the cell first end;
a cell outer surface; and
a cap assembly,
the cap assembly including:
a first cap disposed on the cell first end; and
a second cap disposed on the cell second end,
each of the first cap and the second cap including a tubular body, the body having:
an inner surface that has a shape and dimensions that correspond to the shape and dimensions of the cell outer surface; and
a lip that protrudes inward from the inner surface, the lip disposed at a first end of the body, and a terminal end of the lip defining an opening in the first end of the body.

11. The battery module of claim 10, wherein
the body includes a second end that is opposed to the first end,
each of the first cap and the second cap have a cap length that corresponds to a distance between the first end of the body and the second end of the body,
each cell has a cell length that corresponds to a distance between the cell first end and the cell second end, and
a ratio of the cap length to the cell length is in a range of 0.05 to 0.30.

12. The battery module of claim 10, wherein the body has a second end that is opposed to the first end, and the second end of the body is free of a lip.

13. The battery module of claim 10, wherein the opening has a dimension that is at least 50 percent of a corresponding dimension of the inner surface.

14. The battery module of claim 10, wherein an outer surface of the body includes surface features that enhance fixation of an adhesive to the outer surface.

15. The battery module of claim 10, wherein a first terminal protrudes from the cell first end of each cell, and the opening in the first cap surrounds the first terminal.

16. The battery module of claim 10, wherein
the cell housing of each cell of the cell array is cylindrical, and all the cells of the cell array have the same diameter.

17. The battery module of claim 10, wherein at least one cell of the cell array is the surrounded by other cells of the cell array in such a way that the first cap of the at least one cell is in direct contact with the first cap of six other cells of the cell array, and the second cap of the at least one cell is in direct contact with the second cap of six other cells of the cell array.

18. The battery module of claim 17, wherein the outer surface of the at least one cell is spaced apart from the outer surfaces of the six other cells, and the distance between the outer surface of the at least one cell and the outer surfaces of the six other cells corresponds to twice the thickness of the body, where the thickness of the body is the distance between the inner surface of the body and an outer surface of the body.
